(19) United States
(12) Patent Application Publication
(10) Pub. No.: US 2005/0074697 A1
(43) Pub. Date: Apr. 7, 2005

(54) Method for fabricating masters for imprint lithography and related imprint process

(76) Inventors: Massimo De Vittorio, Lecce (IT); Sergio Bernardi, Torino (IT); Dario Pisignano, Bari (IT); Maria Teresa Todaro, Montesano Salentino (LE) (IT); Roberto Cingolani, Lecce (IT); Giuseppe Gigli, Roma (IT)

Correspondence Address: PERMAN & GREEN, 425 POST ROAD, FAIRFIELD, CT, 06824, US

(21) Appl. No.: 10/945,598

(22) Filed: Sep. 21, 2004

(30) Foreign Application Priority Data
Oct. 4, 2003 (GB) 0323301.2

(51) Int. Cl. G03C 1/76

(52) U.S. Cl. 430/311

(57) ABSTRACT

Masters for imprint processes are produced by providing a resist layer, and patterning the resist layer after a respective mold pattern to produce a patterned resist layer adapted to be directly used as a master for imprint lithography. Preferably the resist is spin cast on a substrate and is comprised of a photoresist, such as negative-tone, electron-beam sensitive resist having a glass transition temperature above 200° C. and adapted to be mechanically stable to pressures up to 10⁴ psi. Preferably, the resist is a polymer resist, such as an epoxy resist e.g. SU8 and SU8-2000. Patterning the resist layer includes the steps of structuring the resist layer, soft-baking the structured resist layer in order to selectively cross-link the structured portion of the structured resist layer and developing the structured resist layer in order to receive a patterned resist layer. The patterned resist layer is preferably cured e.g. by hard-bake curing in order to increase at least one of the mechanical stability and the glass transition temperature of said patterned resist layer. Structuring may be performed by optical lithography or electron beam lithography.

### FIELD OF THE INVENTION

The present invention relates to imprint lithography techniques, and was developed by paying specific attention to the possible application to “nanoimprinting” techniques.

### DESCRIPTION OF THE RELATED ART

Imprint lithography is a process adapted to serve a critical need in the pursuit of ever decreasing feature sizes in integrated circuits, as well as in the development of new devices. Imprint lithography thus represents the key technology for the patterning of materials with a sub-10 nm feature size (nanostructures), allowing a high throughput for a low cost.

“Nanoimprint” lithography (NIL) bases its success on the dramatic decrease in the viscosity of thermoplastic compounds as temperature increases. Above the glass transition temperature of the target compounds, this decrease in viscosity allows transfer of master patterns to be onto many different polymers with very high fidelity. In fact, after placing the master mold onto the polymeric film, the system is driven above the glass transition temperature, T_{g}, of the target and a pressure (usually in the range 10²-10⁴ psi) is applied, thus allowing the polymer to assume the shape of the master.

Among the different physical mechanisms involved in the process, a dominant role is played by the elastic response of the polymer, its viscous response to external stress, and its anelastic behavior determined by the flexibility of the macromolecules.

The final and most critical step in the lithography process is the subsequent cooling down below T_{g}: the vitrification, which occurs upon cooling freezes the pattern into the target polymer, so that the mold can be finally removed. The polymeric pattern, achieved without exposure to radiation, development or etching processes, can then be exploited as a mask for etching or lift-off processes, or as a device itself, as in the case of functional materials like organic semiconductors. The flexibility, the large-area operation and the low-cost typical of NIL makes it a very promising route to nanofabrication.

The realization of direct three-dimensional patterning, nanoscale field effect transistors, metal-semiconductor-metal photodetectors, and sub-10 nm structures have been demonstrated so far.

However, imprinting can be performed on all types of “soft” materials. A wide gamut of molecular and organic materials can thus be imprinted, making this process superior e.g. for producing nanostructures on materials that cannot be exposed to high-energy electrons as used in electron beam lithography, or cannot be processed by standard lithography wet solutions (solvents, remover, stripper, etc.).

To date, master structures for NIL and soft lithography have been realized mainly by conventional lithography followed by wet or reactive ion etching.

In the fabrication of inorganic masters to be used as templates for NIL, particular attention has to be paid to the etching processes. In fact, any possible under-etching in the features of the mold would make it difficult or impossible to detach the master from the target polymer after NIL as a result of penetration of the target polymer within such recessed areas during the thermal cycle. This obviously militates against the possibility of achieving a faithful pattern transfer.

Additionally, any practical embodiment of a nanostructure imprint lithographic system requires a very exact fabrication of the master used as the mold. This mold can then be used for several replicas on the polymer target film, rendering this process capable for high throughput to low cost.

Therefore, the master must exhibit the following features:
a high glass transition temperature (at least greater than the glass transition temperature of the target polymeric material),
a good resistance to the pressure levels used in the process (10²-10⁴ psi),
positive sidewalls, i.e. sidewalls having at the top a lateral dimension smaller than at the bottom, in the absence of under-etching effects: negative sidewalls would in fact prevent the separation between the master and the target polymeric film after the vitrification of the polymeric film,
a high resolution if nanostructures are processed.

A high aspect ratio, i.e. a high ratio of the height to the lateral dimension of the features is also desirable in order to imprint deep structures.

Masters for imprint lithography systems are currently produced by resorting to lithographic definition of the pattern on high resolution optical or electronic resists, followed by wet or dry etching in order to transfer the resist on the substrate of the master.

In fact, while other techniques such as soft hot embossing or capillary force lithography are based on the conformal contact between the target polymer and an elastomeric replica of the original master, NIL employs rigid molds realized by means of conventional lithography techniques and wet or reactive ion etching.

Such etching step is particularly critical and its chemical component must be carefully controlled, as the possible under-etching effect in the mold would make difficult to detach it from the target polymer after NIL. In fact, polymeric molds for NIL can be realized by carrying out the master replication into thermocurable compounds: also in this case a carefully controlled master structure, without under-etching effects, is needed.

The etching of the master must be controlled very carefully in order to guarantee the selectivity, the profile and the aspect ratio of the final structure.

The step of etching is thus the most critical step in the master fabrication process, as this step may be adversely affected by a number of factors/phenomena:
under-etching, which results in negative profiles and thus in a difficult separation of the master from the polymeric target,
low selectivity between the substrate and the resist, which results in a difficult realization of structures with high aspect ratios, and
rigid and fragile substrates, which limit the maximum performable pressure in the imprint process.

Also, masters are typically produced on substrates that are not transparent to visible light (such as e.g. silicon substrates). This makes it very difficult to obtain the re-alignment required in order to perform imprint lithography of nanostructures in multilevel processes on the same substrate or device.

### OBJECTS AND SUMMARY OF THE INVENTION

The object of the present invention is to thus provide an improved method for the fabrication of masters for imprint lithography.

According to the present invention, that object is achieved by means of a method having the features set forth in the claims that follow. The invention also relates to a corresponding imprint lithography process.

In a preferred embodiment of the present invention the master is directly fabricated by patterning of a resist.

Preferably epoxy based resists such as e.g. SU8 or SU8-2000 negative-tone resists (commercially available from MicroChem Corp. of Newton, Mass.—USA) are used. These are high contrast resists designed for micro machining and typically used for producing nearly vertical sidewalls in very thick films. After thermo-curing, such resists exhibit a strong cross-linked network structure, as well as a high glass transition temperature, which exceeds 200° C.

Resists such as those of the SU8/SU8-2000 resist family are electron beam sensitive, thus allowing for electron beam patterning of sub-micron features into a thin resist layer.

While the detailed description that follows will mainly target towards the use of photoresists such as the SU8/SU8-2000 photoresists, the method described herein can be applied to any type of resist such as e.g. electron-beam sensitive resist.

In general, all resists adapted to provide a good mechanical stability and a high glass transition temperature can be used in the method described herein to produce a master for imprinting a target resist comprised of a polymer. The method described herein can be performed with simple process steps in case a photoresist is used. Resist images having exceptionally high aspect ratios and straight sidewalls can be: formed e.g. by contact-proximity or optical projection lithography.

As for the rest, the process steps employed for structuring resists are well known to those of skill in the art, thus making it unnecessary to provide a more detailed explanation herein.

Preferably, after so-called “soft-bake” and development of the optical or electronic lithographic process, an additional “hard-bake” of the exposed structures at a high temperature (such as e.g. about 200° C.) is performed in order to induce further cross-links in the resist network structure, thus increasing the glass transition temperature of the resist and/or improving its mechanical stability. At this point, the thermo-cured and patterned photoresist can be used as a master mold in order to imprint a wide range of target polymers with a lower glass transition temperature.

A possible target could be a polymethylmethacrylate (PMMA) resist that provides excellent mechanical and thermal stability, and high resistance to solvents, acids and bases. Master molds produced by means of resists (such as e.g. the SU8/SU8-2000 photoresists) that provide an excellent mechanical stability and a high glass transition temperature can be used in imprinting any target comprised of a wide range of polymers, molecular, biological and organic materials.

In order to facilitate separation of the mold and the target polymer after imprinting, anti-stick layers, such as e.g. a silane monolayer or a plasma deposited Teflon-like film, can be used to cover the photoresist master.

A main advantage of the method described herein lies in that it dispenses with any etching process in the realization of a master for imprint lithography.

Specifically, the method described herein provides a number of key advantages such as:
direct fabrication of the master through standard patterning steps (such as e.g. optical or electronic beam lithography) and thermo-curing,
the possibility of achieving high aspect ratios (greater than 10) on thick resists (such as e.g. up to 200 microns in case SU8/SU8-2000 photoresists are used),
gray tone structures can be produced in the resist by electron-beam profiling that can be used for a “three dimensional” mold, and
if photoresists such as e.g. SU8/SU8-2000 are used that provide a high transparency in the visible spectrum, the master can be fabricated directly on glass substrates, thus allowing alignment of the lithographic process even onto the polymeric target.

A particularly preferred embodiment of the method described herein provides for polymeric molds for nanoimprint lithography (NIL) being produced by employing an epoxy resin (SU-8) which can be patterned by either UV- or e-beam lithography. In particular, the very low dose (0.5 micro C/cm² at 5 keV) needed for the exposure by e-beam lithography may lead to a strong increase in the efficiency and throughput of the serial fabrication of masters for imprinting. By virtue of the high glass transition temperature (T_{g}) of e.g. SU-8, related to the strongly cross-linked network formed after exposure and baking, the master mold thus obtained can be directly used to imprint polymers with lower T_{g}. This allow a highly faithful pattern transfer and overcomes the problem of the careful etching processes commonly needed to produce molds for imprint lithography. These results substantially improve the performance of NIL in terms of cost and throughput for small scale prototyping both in industrial application and in low-cost laboratories.

A particularly preferred embodiment of the methods described herein provides for polymer molds for NIL being produced either by photo- or y direct electron-beam lithography (EBL) writing onto a negative resist., SU-8. SU-8 is exposed and then thermocured, thus allowing both to exploit the high-resolution of EBL and to avoid any etching process in the realization of NIL masters. In particular, by eliminating the etching step, the experimental simplicity and the throughput strongly increase, while the costs related to pattern fabrication and replication decrease.

### BRIEF DESCRIPTION OF THE ANNEXED DRAWINGS

The invention will now be described, by way of example only, with reference to the annexed drawing, wherein:

FIG. 1 is a flowchart of an exemplary embodiment of the method described herein, and

FIG. 2 to 7 schematically show the results of the separate steps included in the flowchart of FIG. 1.

### DETAILED DESCRIPTION OF PREFERRED EMBODIMENTS OF THE INVENTION

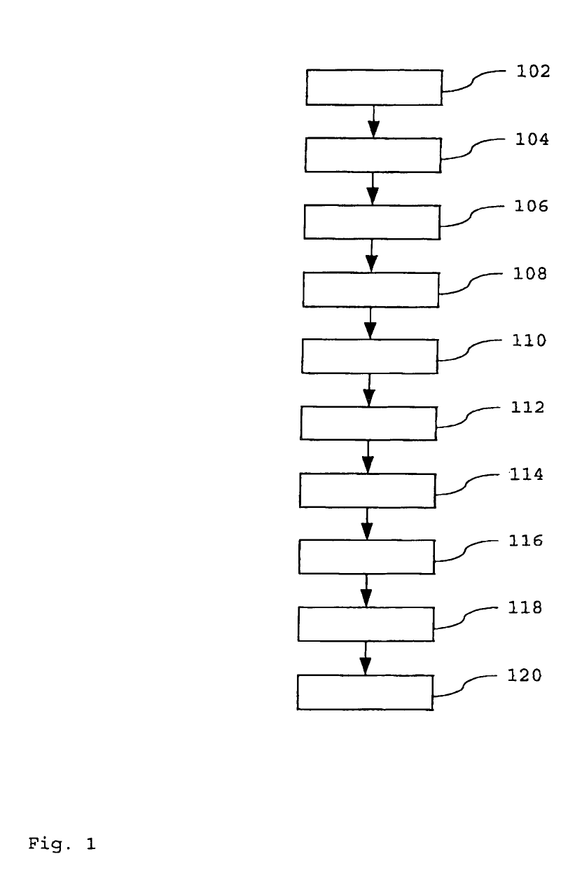

By referring first to the exemplary flowchart FIG. 1 in a first step 102 a resist such as e.g. a SU8 or SU8-2000 photoresist is applied onto a substrate 10 such as e.g. a Si substrate.

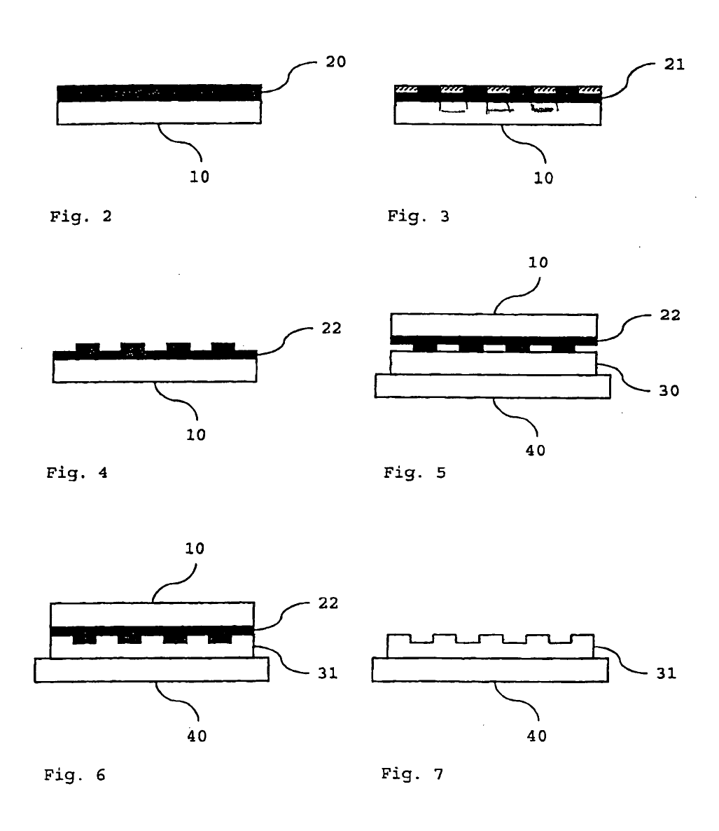

Preferably, the resist is spin cast onto the substrate 10, resulting in a resist layer 20 having a thickness of e.g. 280 nm, as shown in FIG. 2.

In a subsequent step 104 the resist 20 is structured. Structuring may involve exposure to an electron beam as produced e.g. by a Leica LION LV1 EBL with an acceleration energy of 5 keV and gives rise to a structured resist layer 21 as shown in FIG. 3.

In a step 106 the layer 21 is soft-baked in order to selectively cross-link the structured portion of the layer 21 and in a step 108 the layer 21 is developed in order to produce a patterned resist layer 22.

After a hard-bake curing process (e.g. 120 minutes at 180° C.) in a step 110, the layer 22 is ready to be used as the master for imprint lithography as shown in FIG. 4.

Those of skill in the art will promptly appreciated that any set of steps adapted to process the resist layer 20 in order to produce the patterned resist layer 22 can replace the steps 104 to 110.

As shown in FIG. 5, in a step 112 the patterned layer 22 is brought into contact with a target layer 30 distributed (e.g. spin-coated) onto a substrate 40 such as e.g. a GaAs or a Si substrate as shown. The target layer may be e.g. a PMMA resist layer with a molecular weight of 950K and a glass transition temperature of 130° C.

In a step 114 the assembly thus formed is exposed to applied pressure and a temperature increase. Pressure (e.g. about 3×10³ psi) can be applied e.g. by means of a precision manual press such as commercially available from P/O/Weber of Germany as PW100. The temperature is typically up to 225° C. As result, the target layer 30 completely fills the patterned structures of the master layer 22, resulting in a patterned target resist layer 31 with the negative shape of the master layer 22 as shown in FIG. 6.

After cooling down in a step 116, the master mold 22 can be easily separated from the target layer 31 in a step 118 as shown in FIG. 7.

Further processing, as exemplified by a step 120 may include e.g. thermal evaporation of an nm-thick gold layer onto the polymer pattern 31 in order to facilitate SEM investigation.

In particularly preferred embodiments of the method described in the foregoing SU-8 resist was spin-cast onto Si substrates at 4000 rpm for 40″ from cyclopentanone solutions, thus obtaining 280 nm thick resist layers, and then exposed by a Leica LION LV1 EBL system working with an acceleration energy of 5 keV.

The sample thus obtained was soft-baked at a temperature of 65° C. for 1′ in order to selectively cross-link the exposed portion of the film and then developed with MicroChem SU-8 Developer.

A 120″ hard-bake curing process was finally performed onto the master at a temperature of 180° C. Also photolithography was carried out onto high-thickness (≅1.1 μm) SU-8 films, and the obtained structures were used as molds for NIL after cross-linking.

The NIL process was then performed on films of the e-beam resist, polymethyl methacrylate (PMMA) with molecular weight 950K (Allresist, T_{g}≅30° C.), spin-cast on GaAs and Si substrates. NIL on PMMA was performed at temperatures up to 225° C., with a pressure around 3·10³ psi applied by a PW 100 precision manual press.

After cooling down, the patterned sample was easily separated from the master by hand.

Atomic Force Microscopy (AFM) and Scanning Electron Microscope (SEM) measurements were carried out on the SU-8 masters and the imprinted samples. A few nm-thick gold layer was thermally evaporated onto the polymer patterns to facilitate the SEM investigation.

The experiments performed show that a suitable polymer for realizing molds to be used in nanoimprinting should have a softness temperature considerably higher than that of all the target polymers to be patterned: at the temperature of NIL, the structural relaxation time of the material of the mold has to be much longer than that of the target, in order to ensure the rigidity under the pressure applied to transfer the pattern.

Resists such as SU-8 are a negative, epoxy-type resist, commonly employed to obtain high aspect-ratio features by near-UV photolithography. SU-8 can be exposed by deep X-ray lithography and exhibits a high glass transition temperature (200° C.), due to its strongly crosslinked network structure, that make it particularly adapted in producing molds to imprint polymers with lower T_{g}. The additional hard-bake step performed after soft-bake and development, produces further cross-linking in the material, thus increasing T_{g} and improving the mechanical stability of the exposed resist pattern, which can thus be used for imprinting a wide range of target polymers.

Resists such as SU-8 allow to dispense with the etching step in the fabrication of NIL molds, thus increasing the throughput and reducing the overall cost of nanoimprinting, and making such technique more accessible to low-cost laboratories. These resists are thus ideal for fabricate NIL masters, as they combine high processability (being adapted for use as resists for photo- and e-beam lithography) and excellent mechanical stability due to its high T_{g}. Consequently, the hybrid elements comprised of the Si substrate and the patterned SU-8 layer can be used directly as master molds for NIL.

In the experiments carried out by the applicants, master structures realized by EBL onto SU-8, with feature size between 2 and 13 μm were fully satisfactorily imprinted into PMMA imprinted features. The heights of the EBL-fabricated imprinted features, measured by AFM, were found to be the same as that of the master, demonstrating that no deformation occurs in the SU-8 mold at the high temperature and pressure of NIL.

Mechanical stability of SU-8 remains unaffected even at temperatures slightly above. 200° C. Moreover, no tendency of PMMA to adhere to SU-8 to the EBL-made molds during the embossing process was observed, which permits dispensing with an antisticking layer.

Similarly, photolithographycally-made SU-8 master structures were used in a thoroughly satisfactory manner for pattern transfer onto PMMA 950K.

A higher degree of adhesion (“sticking”) was noticed between PMMA and the SU-8 molds made by photolithography, probably as a consequence of quite large height of the interdigitated electrode master structure employed.

Interestingly, resists such as SU-8 can be patterned not only by means of conventional photolithography, but also by EBL, thus allowing very high (in principle sub-100 nm) resolutions to be achieved. In particular, by carrying out dose calibration runs at an EBL acceleration energy of 5 keV, complete cross-linking of the resist layer needs an exposure dose as low as 0.5 μC/cm².

Those of skill in the art will promptly appreciate that this dose value is two orders of magnitude lower than that for a 280 nm thick PMMA 950K layer, which significantly decreases the exposure time required and, in addition to the negative character of the resist, makes it possible to achieve a fast throughput even with serial e-beam systems.

It will thus be appreciated that the method described herein offers a straightforward and experimentally convenient procedure to realize polymeric molds for NIL. A SU-8 epoxy resin was preferably employed as the basic material for the mold by virtue of its excellent structural properties, namely the high glass transition temperature due to the strongly cross-linked network formed after exposure and baking. The polymer-on-silicon masters thus produced are adapted for use in imprinting e.g. PMMA by hot embossing, demonstrating high faithful pattern transfer and overcoming the problems inherent in critical etching processes commonly needed to produce NIL molds. These results substantially improve the performance of NIL in terms of costs and throughput for both industrial application and low-cost laboratories. Also, directly writing on SU-8 by e-beam lithography improves the resolution achieved by photolithography. The very low e-doses (0.5 μC/cm² at 5 keV) needed for the exposure allow fast EBL processes increasing the throughput of the serial fabrication of NIL masters.

It is thus evident that, the basic principles of the invention remaining the same, the details and embodiments may widely vary with respect to what has been described and illustrated purely by way of example, without departing from the scope of the presented invention as defined in the annexed claims.

1. A method for fabricating masters for imprint processes, wherein said masters have respective mold patterns, the method including the steps of:
providing a resist layer, and
patterning said resist layer after a respective said mold pattern to produce a patterned resist layer adapted to be directly used as a master for imprint lithography.

2. The method of claim 1, characterized in that it includes the steps of:
providing a substrate, and
distributing said resist over said substrate to produce said resist layer.

3. The method of claim 2, characterized in that it includes the step of distributing said resist by spin casting said resist on said substrate.

4. The method of claim 1, characterized in that said resist is a photoresist.

5. The method of claim 4, characterized in that said distributed photoresist is a negative-tone photoresist.

6. The method of claim 1, characterized in that said resist is an electron-beam sensitive resist.

7. The method of claim 1, characterized in that said resist is a resist with a glass transition temperature above 200° C.

8. The method of claim 1, characterized in that said resist is a resist, which is mechanically stable to pressures up to 10⁴ psi.

9. The method of claim 1, characterized in that said resist is a polymer resist.

10. The method of claim 1, characterized in that said resist is an epoxy resist.

11. The method of claim 1, characterized in that said resist is selected out of the group consisting of SU8 and SU8-2000 photoresists.

12. The method of claim 1, characterized in that patterning said resist layer includes the step of structuring said resist layer, resulting in a structured resist layer.

13. The method of claim 12, characterized in that patterning said resist layer includes the step of soft-baking said structured resist layer in order to selectively cross-link the structured portion of said structured resist layer.

14. The method of claim 12, characterized in that patterning said resist layer includes the step of developing said structured resist layer in order to produce a patterned resist layer.

15. The method of claim 1, characterized in that it includes the step of curing said patterned resist layer by thermal treatment or exposure.

16. The method of claim 15, characterized in that said step of curing includes hard-bake curing said patterned resist layer.

17. The method of claim 15, characterized in that it includes the step of carrying out said curing by increasing at least one of the mechanical stability and the glass transition temperature of said patterned resist layer.

18. The method of claim 12, characterized in that said structuring is performed by optical lithography.

19. The method of claim 12, characterized in that said structuring is performed by electron beam lithography.

20. The method of claim 12, characterized in that said structuring is performed by X-ray lithography.

21. A method of imprinting a target, including the steps of:
providing a target to be imprinted,
fabricating a master for imprint processes by means of the process of claim 1, and
imprinting said target by means of said master, whereby said target is imprinted with said respective mold pattern.

22. The method of claim 21, characterized in that it includes the steps of:
selecting the material of said target as a material having a lower glass transition temperature than the glass transition temperature of the resist comprising said master,
increasing during imprinting the temperature of the target between the glass transition temperature of the target material and the glass transition temperature of the resist comprising said master.

23. The method of claim 21, characterized in that said target is comprised of a material selected from the group consisting of polymers, molecular, biological and organic materials.

24. The method of claim 21, characterized in that it includes the step of providing an anti-stick layer to facilitate separation of said master and said target imprinted with said respective mold pattern.

25. The method of claim 24, characterized in that said anti-stick layer is comprised of a material selected from the group consisting of a silane layer and a PTFE-like film.
